(19) United States
(12) Patent Application Publication
(10) Pub. No.: US 2008/0271072 A1
(43) Pub. Date: Oct. 30, 2008

(54) Systems and methods for providing live, remote location experiences

(76) Inventors: David Rothschild, San Francisco, CA (US); Justin Cutillo, San Francisco, CA (US)

Correspondence Address: MEDLEN & CARROLL, LLP, 101 HOWARD STREET, SUITE 350, SAN FRANCISCO, CA, 94105, US

(21) Appl. No.: 11/807,809

(22) Filed: May 30, 2007

Related U.S. Application Data
(60) Provisional application No. 60/926,834, filed on Apr. 30, 2007.

(51) Int. Cl. H04N 7/00

(52) U.S. Cl. 725/35

(57) ABSTRACT

The present invention provides systems and methods for experiencing, in real-time, multimedia events from a remote location with ancillary location-associated content. For example, systems and methods of the present invention provide media users or viewers an enhanced, live, local broadcast and related locational information while the user or viewer is located in another geographical location.

The present application claims priority to U.S. Provisional Application No. 60/926,834 filed on Apr. 30, 2007.

### FIELD OF THE INVENTION

The present invention provides systems and methods for experiencing, in real-time, multimedia events from a remote location with ancillary location-associated content. For example, systems and methods of the present invention provide media users or viewers an enhanced, live, local broadcast and related locational information while the user or viewer is located in another geographical location.

### BACKGROUND OF THE INVENTION

There is continuing to be an increase in audio and video information provided over electronic communication networks. For example, there are currently thousands of websites that provide users on-demand video, pictures, or information about different geographical locations. It is also expensive to maintain and manage media-rich content. The success of many such content providers is dependent on generating revenue to support the endeavor. As such, there is a continuous struggle to find viable and sustainable business models that cover such expenses and/or permit a profit.

What is needed are new technologies and models for providing media content.

### SUMMARY OF THE INVENTION

The present invention provides systems and methods for experiencing, in real-time, multimedia events from a remote location with ancillary location-associated content. For example, systems and methods of the present invention provide media users or viewers an enhanced, live, local broadcast and related locational information while the user or viewer is located in another geographical location.

Certain illustrative embodiments of the invention are described below. The present invention is not limited to these embodiments.

In some embodiments, the present invention provides a system comprising a service provider configured to receive and encode multimedia information comprising; audio or video information from a mobile broadcaster, information comprising a locational signal from said mobile broadcaster, and information comprising advertising and non-advertising information associated with the location of the mobile broadcaster. In some embodiments, a locational signal is from a WGS84 coordinate system or a global positioning system or equivalent system. In some embodiments, the service provider further comprises a geographic information system, for example, configured to associate advertising or non-advertising ancillary information with multimedia content provided by a remote broadcaster. In some embodiments, a service provider is further configured to geocode or geotag multimedia information.

In one embodiment, the present invention provides a method for providing locational information comprising; providing audio or video information wherein said audio or video information is geographically referenced, advertising and non-advertising information wherein said information is geotagged, processing said audio or video information wherein said audio or video information is geographically referenced, correlating said geotagged information with said audio or video information wherein said audio or video information is geographically referenced, and providing to a user said geotagged information based on the location of said audio or video information.

In some embodiments, the service provider maintains a database comprising ancillary information, such as advertising or non-advertising information. In some embodiments, the ancillary information in the database contains a geographic identification tag.

### DESCRIPTION OF THE FIGURES

FIG. 1 depicts an exemplary schematic representation of connections between a service provider and the parties providing information to the services provider that is accessible by a user or viewer.

### DEFINITIONS

To facilitate an understanding of the present invention, a number of terms and phrases are defined below:

As used herein, the term “geographic information system” or GIS refers to a system for capturing, storing, analyzing and managing data and associated attributes that are spatially referenced to a physical location of a person, object, or other thing. In one embodiment, it is a computer system capable of integrating, storing, editing, analyzing, sharing, and displaying geographically referenced information. Generally, GIS is a tool that allows users to create interactive queries (user created searches), analyze the spatial information, edit data, maps, and present the results of all these operations.

As used herein, the term “geotagging” or “geocoding” refers to a process of adding geographical identification metadata to various media such as websites, RSS feeds, images, and documents. Data, for example, usually consists of latitude and longitude coordinates, though it can also include altitude and place names or other location-specific identifiers. Geocoding also refers to the process of taking non-coordinate based geographical identifiers, such as a postal address, and converting them into geographic coordinates. Geotagging can help users find a wide variety of location-specific information. For instance, one can find images taken near a given location by entering a latitude and longitude into a geotagging-enabled image search engine. Geotagging-enabled information services can also be used to find news, websites, or other resources. Examples of software for geotagging or geocoding include, but are not limited to, MAPMAKER, MAPMAKER Plus, MAPMAKER World, ALTERYX, ALTAMAP GeoCoder, GEO PINPOINT Suite, and QUICKLOCATE.

As used herein the term “GPS” refers to a global positioning system that provides information corresponding to the geographic location (e.g., in degrees longitude and latitude and altitude) of an individual, object, or broadcaster to a server configured to receive the signal, such as a specialized media server or an information streamer. Examples of GPS units include, but are not limited to, GPS enabled cell phones and service items such as personal digital assistants (PDAs), GPS enabled motor vehicles (e.g., car, motorcycles, motorized scooters, helicopters, airplanes, boats, etc.), GPS hand held units (e.g., units used, for example in backpacking, camping, bicycling, kayaking, etc.), and the like. The present invention is not limited by the type of GPS unit used for location of a mobile broadcaster and/or object. Other systems that provide locational information include the WGS84 coordinate system, which has become something of a default coordinate system with the advent of GPS.

As used herein the term “mobile broadcaster” refers to a subject or object that provides multimedia information from a remote location. Examples of “mobile broadcasters” include, but are not limited to, people, street cars, buses and other tour related vehicles, and the like. As such, a mobile broadcaster is any subject or object that can be fitted with the equipment for broadcasting video, GPS locations, and/or contextual information (advertisments, non-advertisements) along a route.

As used herein the terms “processor” and “central processing unit” or “CPU” are used interchangeably and refer to a device that is able to read a program from a computer memory (e.g., ROM or other computer memory) and perform a set of steps according to the program.

As used herein the terms “multimedia information” and “media information” are used interchangeably to refer to information (e.g., digitized and analog information) encoding or representing audio, video, and/or text. Multimedia information may further carry information not corresponding to audio or video. Multimedia information may be transmitted from one location or device to a second location or device by methods including, but not limited to, electrical, optical, and satellite transmission, and the like. Multimedia information includes, but is not limited to, information furnished from a variety of sources such as advertising companies, non-advertising corporations and organizations, live video or audio from any source (e.g., mobile broadcaster), and the like.

As used herein the term “audio information” refers to information (e.g., digitized and analog information) encoding or representing audio. For example, audio information may comprise encoded spoken language with or without additional audio. Audio information includes, but is not limited to, audio captured by a microphone and synthesized audio (e.g., computer generated digital audio).

As used herein the term “video information” refers to information (e.g., digitized and analog information) encoding or representing video. Video information includes, but is not limited to video captured by a video camera, images captured by a camera, and synthetic video (e.g., computer generated digital video), either live video or otherwise.

As used herein the term “text information” refers to information (e.g., analog or digital information) encoding or representing written language or other material capable of being represented in text format (e.g., corresponding to spoken audio). For example, computer code (e.g., in .doc, .ppt, or any other suitable format) encoding a textual transcript of a spoken audio performance comprises text information. In addition to written language, text information may also encode graphical information (e.g., figures, graphs, diagrams, shapes) related to, or representing, spoken audio. The text information is provided in any desired format (e.g., MICROSOFT, REAL, QUICKTIME, etc.).

As used herein the term “configured to receive” refers to a device that is capable of receiving information. Such devices contain one or more components that can receive a signal carrying information. In some embodiments, the receiving component is further configured to transmit the information to a user via a service provider. For example, a “service provider” or “INTERNET service provider” is configured to receive information from a mobile broadcaster and information from advertising and non-advertising corporations and organizations and send the received information to a system user or viewer.

As used herein the term “encode” refers to the process of converting one type of information or signal into a different type of information or signal to, for example, facilitate the transmission and/or interpretability of the information or signal. For example, audio sound waves can be converted into (i.e., encoded into) electrical or digital information. Likewise, light patterns can be converted into electrical or digital information that provides and encoded video capture of the light patterns. As used herein, the term “separately encode” refers to two distinct encoded signals, whereby a first encoded set of information contains a different type of content than a second encoded set of information. For example, multimedia information containing audio and video information is separately encoded where video information is encoded into one set of information while the audio information is encoded into a second set of information. Likewise, multimedia information is separately encoded where audio information is encoded and processed in a first set of information and text corresponding to the audio information is encoded and/or processed in a second set of information.

As used herein the term “information stream” refers to a linearized representation of multimedia information (e.g., audio information, video information, text information). For example, streaming audio or video information utilizes an information stream. As used herein, the term “streaming” refers to the network delivery of media. “True streaming” matches the bandwidth of the media signal to the viewer's connection, so that the media is seen in real-time. As is known in the art, specialized media servers and streaming protocols are used for true streaming. Real-Time Streaming Protocol (RTSP, REALNETWORKS) is a standard used to transmit true streaming media to one or more viewers simultaneously. RTSP provides for viewers randomly accessing the stream, and uses Real-Time Transfer Protocol (RTP, REALNETWORKS) as the transfer protocol. RTP can be used to deliver live media to one or more viewers simultaneously. “HTTP streaming” or “progressive download” refers to media that may be viewed over a network prior to being fully downloaded. Examples of software for “streaming” media include, but are not limited to, QUICKTIME, NETSHOW, WINDOWS MEDIA, REALVIDEO, REALSYSTEM G2, REALSYSTEM 8, CLIPSTREAM, REALAUDIO, C-NARIO Media Suite, Maestro Management Suite, PeerStream 4, Lightstreamer, etc. A system for processing, receiving, and sending streaming information may be referred to as a “stream encoder” and/or an “information streamer.”

As used herein the term “configured to receive multimedia information” refers to a device that is capable of receiving multimedia information. Such devices contain one or more components that can receive a signal carrying multimedia information. In preferred embodiments, the receiving component is configured to transmit the multimedia information to a processor.

As used herein, the term “client-server” refers to a model of interaction in a distributed system in which a program at one site sends a request to a program at another site and waits for a response. The requesting program is called the “client,” and the program that responds to the request is called the “server.” In the context of the World Wide Web (discussed below), the client is a “Web browser” (or simply “browser”) that runs on a computer of a user; the program which responds to the browser requests by serving Web pages is commonly referred to as a “Web server.”

As used herein, the term “INTERNET” refers to any collection of networks using standard protocols. For example, the term includes a collection of interconnected (public and/or private) networks that are linked together by a set of standard protocols (such as RTP, TCP/IP, HTTP, and FTP) to form a global, distributed network. While this term is intended to refer to what is now commonly known as the INTERNET, it is also intended to encompass variations that may be made in the future, including changes and additions to existing standard protocols or integration with other media (e.g., television, radio, etc). The term is also intended to encompass non-public networks such as private (e.g., corporate) Intranets.

As used herein the terms “live video” refers to an event that is to be captured in the form of audio, video, text, or multimedia information, wherein the captured information is used to transmit a representation of the event (e.g., a video, audio, or text capture of the event) to one or more viewers in real time or substantially real time (i.e., it will be appreciated that delays on the order of seconds to minutes may be incurred in the capture, delivery, and/or processing of information prior to its display to viewers while still considering the display of the event as a “live” event). As used herein, “live audio” refers to audio from a live event that is captured as audio information and transmitted, in some form, to a viewer in real time.

As used herein the terms “distinct locations” and “different locations” refer to two or more different physical locations where viewers can separately view a multimedia presentation. For example, a person viewing a presentation in one location (e.g., on a video monitor) would be in a distinct location from a second person viewing the same presentation (e.g., on a different video monitor) if the first and second persons are located in different rooms, cities, countries, and the like.

As used herein the terms “viewer” or “user” are interchangeable and refer to a person who accesses text, audio, video, or multimedia content.

### DETAILED DESCRIPTION OF THE INVENTION

Certain illustrative embodiments of the invention are described below. The present invention is not limited to these embodiments.

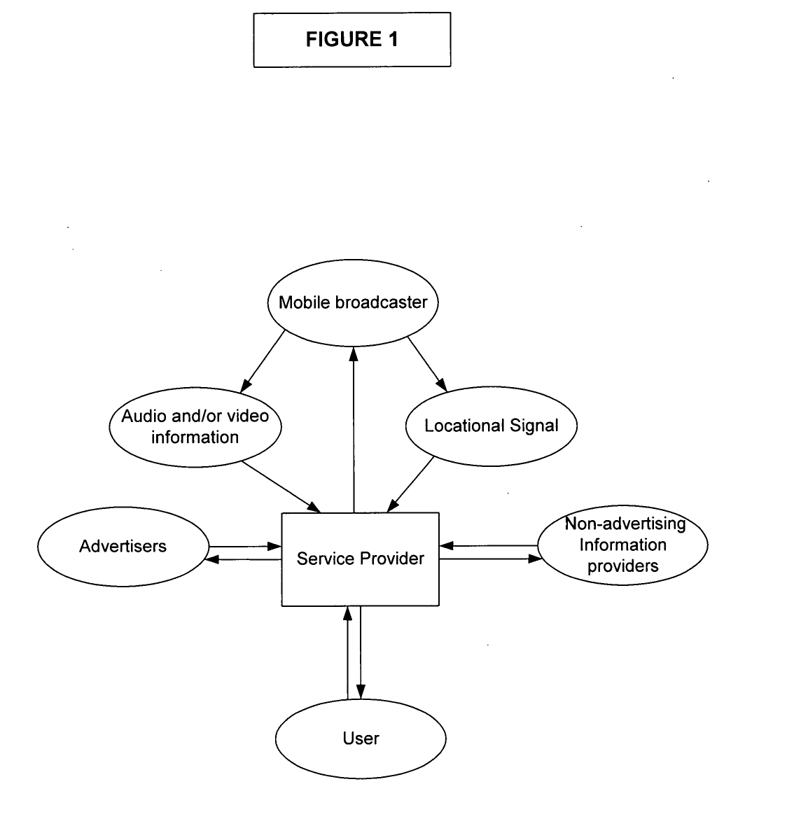

The present invention provides systems and methods for receiving and distributing information (e.g., location specific information and advertising) based on the location of a mobile broadcaster, for live multimedia experiences. As seen in FIG. 1, systems and methods of the present invention comprise a service provider that is configured to receive multimedia and locational information from a mobile broadcaster. For example, a mobile broadcaster sends a locational signal (e.g., provided by a geographic locational device such as a GPS or WGS84 coordinate system) and multimedia information (e.g., audio and/or video information) that is received by a service provider. The service provider is further configured to receive and, if necessary geotag or geocode, multimedia information as provided by advertisers (e.g., businesses such as coffee shops, restaurants, department stores, real estate agencies, book stores, travel agencies, Chamber of Commerce, theaters, museums, sports arenas, live events, and the like) and non-advertising information providers (e.g., news, weather, historical information, and the like). A service provider, upon receiving multimedia information and a locational signal from a mobile broadcaster, is configured to provide a user a live feed of the multimedia content as well as the advertising and non-advertising information based on the information provided by a mobile broadcaster. The advertising or non-advertising information is selected so as to correspond to, associate with, or otherwise have some tie to the location of the remote broadcaster and/or the multimedia content provided by the mobile broadcaster. As such, systems and methods of the present invention provide a user with live broadcast and related locational information.

In one embodiment, the systems and methods of the present invention comprise a service provider configured to receive multimedia information from a variety of sources (e.g., mobile broadcaster, advertisers, non-advertising information providers). In some embodiments, the service provider is configured to receive multimedia information and provide real-time locational, multimedia information to a user. In some embodiments, the service provider controls a server configured to receive video and/or audio information. The service system may comprise one or more computer systems, at one or more locations, configured to receive, store, associate, and transmit information.

In some embodiments, the server is further configured to receive a locational signal (e.g., global positioning signal) and correlate that signal with the video and/or audio information. In some embodiments, the service provider comprises a geographic information system. In some embodiments, the service provider is configured to geotag or geocode received multimedia information that is not otherwise so configured. In some embodiments, the service provider is configured to receive locational and multimedia information from a mobile broadcaster, correlate that information with geotagged or geocoded multimedia information (e.g., as provided by advertisers, non-advertising information providers, or geotagged or geocoded by a service provider), and provide a user geotagged information as it relates to the location of a mobile broadcaster. In some embodiments, the service provider is configured to provide advertising or non-advertising geotagged information to a user on a timed basis. For example, a service provider is configured to provide a user with information (e.g., advertisements, historical information, etc.) for a minimum amount of time prior to displaying additional, different geotagged information. The present invention is not limited to a particular time limit for displaying geotagged information from an advertiser or non-advertising information provider. In some embodiments, the time limit for display of information is at least 3 seconds, at least 5 seconds, at least 10 seconds, at least 15 seconds, or at least 20 seconds.

In some embodiments, image information from advertisers and non-advertisers that is provided to a user by a service provider is provided in a smooth fashion. For example, the information provided to the viewer flows together, and is not limited to distinct stop motion types of viewing. Such a flow of information can be provided by, for example, the process of “in-betweening,” wherein intermediate frames between two images are generated, giving the appearance that the first image evolves, or changes, smoothly into the second image. Inbetweens are the images between the key images that help create the illusion of fluid motion when frames of information change. The present invention is not limited to the type of application that provides for a smooth transition from one image to the next, and any application capable of performing such transitions find utility with the present invention.

In some embodiments, a service provider is configured to provide a user with a live feed of the multimedia content as well as the advertising and non-advertising information on the basis of geotagged information received from more than one mobile broadcaster. For example, in one embodiment, a service provider is configured to provide a user with live feed of the multimedia content as well as the advertising and non-advertising information if more than a predetermined number of broadcasters are within a specific distance of each other. In some preferred embodiments, the number of mobile broadcasters is at least 2, at least 4, at least 10, at least 20 and the distance at least 10 meters, at least 20 meters, at least 50 meters, or at least 100 meters.

In some embodiments, the service provider is configured to provide information back to the advertisers, non-advertising information providers, and mobile broadcaster. In some embodiments, the service provider is configured to provide back to the mobile broadcaster statistics on the number of viewers that viewed a particular broadcast. The service provider can also provide viewer requests (e.g., requests for topics for upcoming broadcasts, requests for re-playing of a particular broadcast, etc.) to the mobile broadcaster to aid in development of present or future broadcasting. In some embodiments, the service provider provides information back to advertisers and non-advertisers. In some embodiments, information regarding user information, statistical information, payment indicators (e.g., number of hits an advertiser has for a particular geotagged piece of information thereby generating a bill for payment to the service provider), and the like is provided back to the advertiser or non-advertiser by the service provider.

In some embodiments, the service provider is configured to receive information about the environment surrounding, or in the vicinity of, the mobile broadcaster including, but not limited to, temperature, humidity, wind speed and direction, allergen levels (e.g., pollen, mold, etc.), pollutant levels (e.g., smog), carbon monoxide reports, and other biologically active agents relative to health. Such information is, for example, ascertained by correlating locational information with web based information sources such as pollen.com that provides pollen levels based on location. Alternatively, this information is derived directly from the mobile broadcaster suitably equipped with environmental sensors such as digital temperature gauges, pollution monitors, etc. Environmental sensors are well known in the art of personal mobile environmental sensing and are continuously being improved, as such future environmental sensors also find utility in the present invention. One example of an environmental sensing system is the recently established MESSAGE project (Mobile Environmental Sensor Systems Across a Grid Environment). This project is funded by the UK Engineering and Physical Sciences Research Council and the UK Department for Transport, and involves collaboration between a multidisciplinary team of researchers based at Imperial College London and the Universities of Cambridge, Leeds, Newcastle and Southampton. (http://ercim-news.ercim.org/content/view/106/248/). Inexpensive sensing equipment which is added to mobile phones and provides both location and environmental information is being developed and is contemplated to have utility in providing environmental information as previously described http://www.smartmobs.com.

In some embodiments, the geotagged information is displayed, for example, as a frame, pop-up, banner, or other mode of display, on a display device. Display devices include, but are not limited to, computer monitors (e.g., via the INTERNET or INTRANET), television screens, hand-held video devices, portable media players (e.g., iPOD, iPHONE, digital audio players (DAPs), ARCHOS PMP products, COWAN A3, PHILIPS portable media player, and the like), cell phones, PDAs, and the like. In some embodiments, multiple advertisements (e.g., multiple, different advertisements) are displayed at the same time based on user information. In some embodiments, advertisements are displayed to a user based on user-selected preferences that are stored on a display device. In other embodiments, advertisements are displayed to a user based on user information provided by tracking the activities, history, demonstrated preferences, biographical information, etc. of the user. In some embodiments, the service provider is further provided information about the user's viewing system so that content can be properly formatted.

Current cellular broadband (EVDO Rev-A) allows for high mobile upload speeds thereby making it possible for live webcam feed from a mobile broadcaster that is received by a service provider. Previous webcams required that the camera be directly connected to the broadband connection, however current wireless technologies (e.g., WiFi, Wi-Max, etc.) allow for a live webcam feed from a mobile broadcaster that is remotely received by a service provider configured to receive signals from a mobile broadcaster. The present invention is not limited by the methods and architecture of the service provider's system, or what programs or services accessed by a service provider the provide methods of the present invention. For example, it is contemplated that a service provider is configured to utilize, an open source Flash server, such as Red5 (www.osflash.org), or any other open source Flash server that supports streaming and recording audio/video, live stream publishing and Flash remoting. In some embodiments, an open source server, such as Red5, is coupled with a web service that provides resizable compute capacity, such as Amazon's Elastic Compute Cloud (EC2) web service, which is designed to make web-scale computing easier for developers. Such a web service, as exemplified by Amazon EC2, allows service providers to, for example, use web service interfaces to requisition machines for use, load them with custom application environments, manage a network's access permissions, and run images using as many or few systems as required. Additional wireless applications useful in embodiments of systems and methods of the present invention include, but are not limited to, peer-to-peer (P2P) live streaming video feed from a mobile broadcaster (e.g., peercasting). As such, provide scalable systems for the service provider based on demand by users, for example. A skilled artisan will recognize the myriad of options available at any given time that would be amenable to a service provider to provide services as provided by the present invention.

In some embodiments, the service provider is configured to receive multimedia from a variety of sources, for example, from a mobile broadcaster, advertisers, non-advertising information providers, and the like. In some embodiments, a service provider in configured to receive multimedia information from a mobile broadcaster. A mobile broadcaster sends, for example, live audio and/or live video to a service provider. Live audio and/or video includes any type of information including, but not limited to, topical information relating to architecture, cultural sites, culinary tours, historical locations, and the like. In preferred embodiments, the multimedia from a mobile broadcaster is geographically referenced based on a locational signal sent by the mobile broadcaster and received by a service provider. For example, a mobile broadcaster provides a service provider with live audio and/or live video and a locational signal from a global positioning system or WGS84, or another type of system capable of geographically (e.g., longitude, latitude, and/or altitude) locating a mobile broadcaster. For example, a mobile broadcaster carries a GPS enabled cell phone or other GPS enabled device (e.g., pagers, PDAs, GPS hand-held mobile units, etc.), wherein said GPS device is constantly broadcasting the geographical location of the mobile broadcaster to the service provider configured to receive such a signal thereby providing the service provider with the location, at any given time, of the mobile broadcaster.

In further embodiments, the locational device, such as a GPS unit, shows the real time location of the mobile broadcaster, locations of storefronts, advertising and non-advertising information, and the like to a user directly on-screen on a map or the like, thereby furnishing the user with positional real time locations and related information. For example, a mobile broadcaster is passing a retail store. As the mobile broadcaster passes the store, a map or other locational visual tool will appear to the user denoting where the mobile broadcaster is, and where the retail store is as well, along with information pertaining to retail store. Such real time locational information is provided by GPS coordinates and the geotagged information available for distribution to a user in the service provider databases.

In some embodiments, methods and systems of the present invention provide a proximity-advertising model. For example, advertisers in a defined location provide information to a service provider configured to receive multimedia information whereupon the advertisements are provided to users based on the location (e.g., via GPS signal) of the mobile broadcaster, and the location of the product being advertised in relation to the mobile broadcaster. For example, a user views a mobile broadcaster walking past a store that has furnished information to a service provider. As the mobile broadcaster passes (or is deemed to be in proximity to, via global positioning) the store, an advertisement relating to that store is provided to the user (e.g., viewer) for a limited period of time (e.g., at least 3 seconds, at least 5 seconds, at least 10 seconds, at least 15 seconds, at least 20 seconds, etc.). Information about the store is available to the user such that a user has ample time to view advertisements for different stores even though advertisements for several different stores are provided to a user at the same time. In some embodiments, links are provided so that the user can obtain additional information about the advertiser, can purchase a product or service, etc. Examples of advertising and advertisements received by a service provider for providing to a user include, but are not limited to, advertising related to restaurants, bars, coffee shops, book stores, department stores, cinemas, and the like. As such, systems and methods of the present invention provide advertisers real-time advertising based on the location of a mobile broadcaster, wherein a viewer not only sees live video of the location being advertised (e.g., book store, coffee store, department store, real estate for sale, etc.) but also is provided additional information about what is being advertised (e.g., store hours, products offered for sale, special offers, real estate prices, information on a house for purchase, etc.).

In some embodiments, the present invention further provides an online presence for retail stores and retail service providers and the like that is available to the user for the direct purchasing of goods and services during the interactive presentation of the mobile broadcaster. For example, if a mobile broadcaster passes a retail store, an online link to a retail store is furnished the user such that the user can purchase goods and services at that time from the retail store. As such, advertisers using the methods of the present invention realize immediate online sales, and a real life shopping experience is furnished the user when local retail stores provide an online purchasing presence.

In some embodiments, the service provider is configured to maintain an archive of past mobile broadcasts. In some embodiments, the service provider is configured to allow a user access to those archives, wherein a user can request from the service provider access to one or more archived broadcasts, thereby experiencing the previously recorded broadcaster, including all the geotagged information, associated links, etc. as experienced during the live broadcast. As well, it is contemplated that archival broadcasts can be updated to include information not originally present in the broadcast. For example, a retail store, museum, cinema, etc. is built in a location previously passed by a mobile broadcaster during a live presentation. Advertising and non-advertising information relating to that new store and the like can be added to an archived broadcast such that the archived information is constantly being updated to include additional, new information for a particular location, store, museum, etc.

Embodiments of the present invention provide a user the opportunity to experience a remote location relative to the location of the user. For example, the user could be sitting in his or her own living room, INTERNET bar, or any other location different from the location of a mobile broadcaster. In some embodiments, the user accesses the experience, for example, on a computer, a cell phone capable of receiving a wireless signal (e.g., RTP enabled cell phone), or on another type of device (e.g., television, PDA, etc.) that is configured to receive a signal that conveys the information (e.g., using a transfer control protocol (TCP), INTERNET protocol (IP), and/or a real-time transfer protocol (RTP)). In some embodiments, the experiences provided a user include, but are not limited to, real-time live video, real-time live audio, advertising targeted to a distinct location, weather and news targeted to a distinct location, real estate listing for a distinct location, historical information on historical things and places, and/or event information for a distinct location. In some embodiments, a user accesses real time locations of mobile broadcasters at any given time. For example, a service provider is configured to communicate with an application such as that provided by a mapping location provided by Google™ Earth, a broadband 3-dimensional application for providing maps and satellite images for complex or pinpointed GPS locations. In some embodiments, a user queries Google™ Earth for the location of one or more (e.g., all) mobile broadcasters, and is able to log into the presentation of a particular mobile broadcaster at any given time.

Further, in some embodiments the present invention provides users the opportunity to take control and direct the actions of a mobile broadcaster. For example, a user, through voice, text, GPS directionality communication, and the like, communicates what the user wants the mobile broadcaster to do, where to go, etc. In some embodiments, a user gains the ability to direct a mobile broadcaster by any means, including, but not limited to, paying for the privilege privately, through an online bidding system wherein the highest bidder is granted the ability to direct the mobile broadcaster, etc. For example, a user at home is experiencing a mobile broadcast and decides he/she wants to direct the broadcaster to another location. The user, through whatever means available, is granted the privilege of directing the mobile broadcaster to do whatever the user wants, including but not limited to, talking to people, visiting a specific location, shopping and/or browsing specific storefronts, and even purchasing merchandise based on pre-furnished information to a mobile broadcaster by a user.

In some embodiments, the mobile broadcaster is, for example, giving a tour of a location (e.g., in a city) and providing live video and a locational signal to a service provider configured to receive the video and locational signal (e.g., GPS signal), wherein the system provider in turn provides the live video to a user along with locational relevant information based on the location of the mobile broadcaster. For example, the mobile broadcaster gives a walking or driving tour of a city. Subject matter provided in such a tour includes, but is not limited to, a tour of restaurants, a tour of architectural features, a tour of historic places, tours of available real estate, and the like. In some embodiments, as a mobile broadcaster passes (for example) a particular place or building, information concerning that place or building (e.g., historical information about the place or building) is provided to a viewer as the mobile broadcaster is passing, or is in proximity to, that place or building. In some embodiments, the information is provided to the viewer for a limited period of time (e.g., at least 3 seconds, at least 5 seconds, at least 10 seconds, at least 15 seconds, at least 20 seconds). In some embodiments, a historical link is provided to viewed information so that the user can access any previously viewed (or missed) information at any desired time.

In some embodiments, the mobile broadcaster, due to its ability to quickly react to real time situations, is able to reach the scene of news generating locations, and provide real time news broadcasts at a particular location, which is further viewed on a map or location tool as previously described. For example, there is a big fire in a city. A mobile broadcaster, due to increased mobility over large news crews, is able to relocate to the fire faster, while at the same time providing relevant news information to a viewer as the broadcaster moves in and around the fire (e.g., or other news worthy event). As such, the present invention further provides a user a novel type of live news broadcast, wherein news is updated and provided contextually to a specific location (e.g., based on geotagging and GPS locational information) where the news is happening.

All publications and patents mentioned in the present application are herein incorporated by reference. Various modification and variation of the described methods and compositions of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A system comprising a service provider, said service provider configured to receive and encode multimedia information comprising; audio or video information from a mobile broadcaster, information comprising a locational signal from a mobile broadcaster, and information comprising advertising and non-advertising information associated with the location of the mobile broadcaster.

2. The system of claim 1, wherein said locational signal is provided from a WGS84 coordinate system or a global positioning system or equivalent system.

3. The system of claim 1, wherein said service provider further comprises a geographic information system.

4. The system of claim 3, wherein said geographic information system is configured to associate advertising or non-advertising ancillary information with multimedia content provided by a remote broadcaster.

5. The system of claim 1, wherein said service provider is further configured to geotag or geocode multimedia information.

6. The system of claim 1, wherein said service provider further maintains a database comprising ancillary information.

7. The system of claim 6, wherein said ancillary information comprises advertising and non-advertising information.

8. The system of claim 6, wherein said ancillary information contains a geographic identification tag.

9. A method for providing locational information comprising;
a) providing:
i) audio or video information, wherein said audio or video information is geographically referenced,
ii) advertising and non-advertising information wherein said advertising and non-advertising information in geotagged,
b) processing said audio or video information, wherein said audio or video information is geographically referenced,
c) correlating said geotagged information with said audio or video information, wherein said audio or video information is geographically referenced, and
d) providing to a user said geotagged information based on the location of said audio or video information.
